(19) United States
(12) Patent Application Publication
(10) Pub. No.: US 2008/0226817 A1
(43) Pub. Date: Sep. 18, 2008

(54) TILTED PERPENDICULAR MAGNETIC RECORDING MEDIA AND METHOD AND APPARATUS THEREFOR

(75) Inventor: Jean Ling Lee, San Jose, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC, Scotts Valley, CA (US)

(21) Appl. No.: 12/049,983

(22) Filed: Mar. 17, 2008

Related U.S. Application Data
(62) Division of application No. 10/448,396, filed on May 30, 2003, now abandoned.

(51) Int. Cl. G11B 5/84

(52) U.S. Cl. 427/130; 118/52

(57) ABSTRACT

Disclosed is a perpendicular magnetic recording medium comprising:
(a) a non-magnetic substrate including a surface with a stack of thin-film layers formed thereon; and
(b) a tilted perpendicular magnetic recording layer on the surface of an outermost layer of said layer stack, wherein the easy axis of magnetization of magnetic particles of said recording layer is tilted in a radial direction at a preselected, controllable angle up to about 45° from vertical. Also disclosed are a method and apparatus for forming perpendicular magnetic recording media with controllably tilted perpendicular magnetic recording layers.

### FIELD OF THE INVENTION

The present invention relates to highly anisotropic, “tilted” perpendicular magnetic recording media with improved signal-to-medium noise ratio (“SMNR”), a method of manufacturing same, and an apparatus therefor. The invention is of particular utility in the fabrication of data/information storage and retrieval media, e.g., hard disks, having ultra-high areal recording/storage densities.

### BACKGROUND OF THE INVENTION

Magnetic media are widely used in various applications, particularly in the computer industry, and efforts are continually made with the aim of increasing the areal recording density, i.e., bit density of the magnetic media. In this regard, so-called “perpendicular” recording media have been found to be superior to the more conventional “longitudinal” media in achieving very high bit densities. In perpendicular magnetic recording media, residual magnetization is formed in a direction perpendicular to the surface of the magnetic medium, typically a layer of a magnetic material on a suitable substrate. Very high linear recording densities are obtainable by utilizing a “single-pole” magnetic transducer or “head” with such perpendicular magnetic media.

It is well-known that efficient, high bit density recording utilizing a perpendicular magnetic medium requires interposition of a relatively thick (i.e., as compared to the magnetic recording layer), magnetically “soft” underlayer or “keeper” layer, i.e., a magnetic layer having a relatively low coercivity of about 1 kOe or below, such as of a NiFe alloy (Permalloy), between the non-magnetic substrate, e.g., of glass, aluminum (Al) or an Al-based alloy, and the “hard” magnetic recording layer having relatively high coercivity of several kOe, typically about 3-6 kOe, e.g., of a cobalt-based alloy (e.g., a Co—Cr alloy such as CoCrPtB) having perpendicular anisotropy. The magnetically soft underlayer serves to guide magnetic flux emanating from the head through the hard, perpendicular magnetic recording layer. In addition, the magnetically soft underlayer reduces susceptibility of the medium to thermally-activated magnetization reversal by reducing the demagnetizing fields which lower the energy barrier that maintains the current state of magnetization.

A typical conventional perpendicular recording system 10 utilizing a vertically oriented magnetic medium 1 with a relatively thick soft magnetic underlayer, a relatively thin hard magnetic recording layer, and a single-pole head, is illustrated in FIG. 1, wherein reference numerals 2, 3, 4, and 5, respectively, indicate a non-magnetic substrate, a soft magnetic underlayer, at least one non-magnetic interlayer, and a perpendicular hard magnetic recording layer. Reference numerals 7 and 8, respectively, indicate the single and auxiliary poles of a single-pole magnetic transducer head 6. The relatively thin interlayer 4 (also referred to as an “intermediate” layer), comprised of one or more layers of non-magnetic materials, serves to (1) prevent magnetic interaction between the soft underlayer 3 and the hard recording layer 5 and (2) promote desired microstructural and magnetic properties of the hard recording layer.

As shown by the arrows in the figure indicating the path of the magnetic flux φ, flux φ is seen as emanating from single pole 7 of single-pole magnetic transducer head 6, entering and passing through vertically oriented, hard magnetic recording layer 5 in the region above single pole 7, entering and travelling along soft magnetic underlayer 3 for a distance, and then exiting therefrom and passing through the perpendicular hard magnetic recording layer 5 in the region above auxiliary pole 8 of single-pole magnetic transducer head 6. The direction of movement of perpendicular magnetic medium 1 past transducer head 6 is indicated in the figure by the arrow above medium 1.

With continued reference to FIG. 1, vertical lines 9 indicate grain boundaries of each polycrystalline (i.e., granular) layer of the layer stack constituting medium 1. As is apparent from the figure, the width of the grains (as measured in a horizontal direction) of each of the polycrystalline layers constituting the layer stack of the medium is substantially the same, i.e., each overlying layer replicates the grain width of the underlying layer. A protective overcoat layer 11, such as of a diamond-like carbon (DLC) is formed over hard magnetic layer 5, and a lubricant topcoat layer 12, such as of a perfluoropolyethylene material, is formed over the protective overcoat layer. Substrate 2 is typically disk-shaped and comprised of a non-magnetic metal or alloy, e.g., Al or an Al-based alloy, such as Al—Mg having an Ni—P plating layer on the deposition surface thereof, or substrate 2 is comprised of a suitable glass, ceramic, glass-ceramic, polymeric material, or a composite or laminate of these materials; underlayer 3 is typically comprised of an about 500 to about 4,000 Å thick layer of a soft magnetic material selected from the group consisting of Ni, NiFe (Permalloy), Co, CoZr, CoZrCr, CoZrNb, CoFe, Fe, FeN, FeSiAl, FeSiAlN, FeCoB, FeCoC, etc.; interlayer 4 typically comprises an up to about 300 Å thick layer of a non-magnetic material, such as TiCr; and hard magnetic layer 5 is typically comprised of an about 100 to about 250 Å thick layer of a Co-based alloy including one or more elements selected from the group consisting of Cr, Fe, Ta, Ni, Mo, Pt, V, Nb, Ge, B, and Pd, iron oxides, or a (CoX/Pd or Pt)ₙ multilayer magnetic superlattice structure, where n is an integer from about 10 to about 25, each of the alternating, thin layers of Co-based magnetic alloy is from about 2 to about 3.5 Å thick, X is an element selected from the group consisting of Cr, Ta, B, Mo, Pt, W, and Fe, and each of the alternating thin, non-magnetic layers of Pd or Pt is about 1 Å thick. Each type of hard magnetic recording layer material has perpendicular anisotropy arising from magneto-crystalline anisotropy (1^{st} type) and/or interfacial anisotropy (2^{nd} type).

“Tilted” perpendicular magnetic recording media, i.e., media in which the easy axis of magnetization of a perpendicular recording layer is tilted with respect to the writing and reading magnetic fields applied thereto by a read/write transducer, have been proposed as a means for enabling writing of very highly anisotropic perpendicular magnetic recording media with improved signal-to-medium noise ratios (SMNR) which are not achievable with conventional methodology. Specifically, for a given perpendicular writing field, the maximum coercivity (and anisotropy) of an ideal Stoner-Wohlfarth magnetic particle (i.e., a very small, elliptically-shaped magnetic particle having a single magnetic domain, facilitating modeling of M-H hysteresis loops when a magnetic field is applied at an arbitrary angle with respect to the easy axis of the particle) can be increased two-fold by increasing the angle between the applied magnetic field of the read/write transducer and the easy axis of magnetization of the magnetic particle from 0 to 45°.

For rotating disk media with a bit width to bit length aspect ratio >1, the tilt direction of the easy axis of magnetization is considered to lie in the radial direction. However, to date the development of a practical means for manufacturing perpendicular magnetic recording disks with the requisite radially tilted easy axis (i.e., c-axis) orientation remains a challenge.

In view of the above, there exists a clear need for improved, high areal recording density, highly anisotropic, radially tilted perpendicular magnetic information/data recording, storage, and retrieval media which facilitate writing thereof and exhibit increased signal-to-media noise ratios (SMNR). In addition, there exists a need for an improved method for manufacturing such high areal recording density, highly anisotropic, radially tilted perpendicular magnetic recording media, and apparatus therefor, which methodolgy can be readily and economically practiced.

The present invention, therefore, addresses and solves problems attendant upon obtaining reliable, cost-effective manufacture of high bit density, highly anisotropic, tilted perpendicular magnetic media. Moreover, manufacture of the magnetic media of the present invention is advantageously fully compatible with the economic requirements of large-scale, automated manufacturing technology.

### DISCLOSURE OF THE INVENTION

An advantage of the present invention is an improved method of manufacturing a magnetic recording medium comprising a radially oriented tilted perpendicular magnetic recording layer.

Another advantage of the present invention is an improved magnetic recording medium comprising a radially oriented tilted perpendicular magnetic recording layer.

Yet another advantage of the present invention is an improved apparatus for manufacturing a magnetic recording medium comprising a radially oriented tilted perpendicular magnetic recording layer.

Additional advantages and other features of the present invention will be set forth in the description which follows and in part will become apparent to those having ordinary skill in the art upon examination of the following or may be learned from the practice of the present invention. The advantages of the present invention may be realized as particularly pointed out in the appended claims.

According to an aspect of the present invention, the foregoing and other advantages are obtained in part by a method for manufacturing a magnetic recording medium, comprising sequential steps of:

(a) providing a precursor workpiece for a perpendicular magnetic recording medium; and

(b) forming a tilted perpendicular magnetic recording layer on the precursor workpiece, wherein the easy axis of magnetization of magnetic particles of the recording layer is tilted in a radial direction at a preselected, controllable angle up to about 45° from vertical.

According to embodiments of the present invention, step (a) comprises providing a precursor workpiece including a non-magnetic substrate with at least one requisite thin film layer for a perpendicular magnetic recording medium formed thereon; and step (b) comprises forming the tilted perpendicular magnetic recording layer on the outer surface of the at least one thin film layer; wherein: step (a) comprises providing a disk-shaped precursor workpiece and rotating the precursor workpiece about a central axis; and step (b) comprises forming a spin-coated, radially tilted perpendicular magnetic recording layer on the outer surface of the at least one thin film layer by dispensing thereon a dispersion, slurry, or suspension of the magnetic particles in a vehicle or carrier liquid while applying a magnetic alignment field thereto which is tilted at a preselected controllable angle up to about 45° from vertical.

Embodiments of the method of the present invention comprise a further step of:

(c) removing the vehicle or carrier liquid from the spin-coated layer, as by heating the spin-coated tilted perpendicular magnetic recording layer at a temperature below the Curie temperature of the magnetic particles; whereas, according to other embodiments of the invention, step (b) comprises forming the spin-coated tilted perpendicular magnetic recording layer on the outer surface of the at least one thin film layer by dispensing thereon a dispersion, slurry, or suspension of the magnetic particles in a vehicle or carrier liquid comprising a silica sol-gel in a solvent, and step (c) comprises removing the solvent to form a tilted perpendicular magnetic recording layer comprising the magnetic particles embedded in a glass-like matrix derived from the silica sol-gel.

Additional embodiments of the method of the present invention comprise a still further step of:

(d) annealing the spin-coated tilted perpendicular magnetic recording layer.

Preferred embodiments of the present invention include those wherein step (a) comprises providing a disk-shaped precursor workpiece including a non-magnetic substrate comprised of a material selected from the group consisting of non-magnetic metals or alloys, glass, ceramics, glass-ceramics, polymeric materials, and composite or laminates of same; and the at least one thin film layer for a perpendicular magnetic recording medium includes an underlayer or keeper layer of a soft magnetic material, or a combination of an underlayer or keeper layer of a soft magnetic material and an overlying non-magnetic interlayer forming an outermost layer of a layer stack; wherein: step (a) comprises rotating the precursor workpiece about the central axis at a speed proportional to the viscosity of the dispersion, slurry, or suspension of magnetic particles; and step (b) comprises dispensing a dispersion, slurry, or suspension of nano-sized magnetic particles selected from the group consisting of: CoPt magnetic alloys, FePt magnetic alloys, and other magnetic alloys utilized for forming perpendicular magnetic recording layers.

According to particular embodiments of the present invention, step (a) comprises rotating the precursor workpiece at a speed from ˜1,000 rpm to ˜5,000 rpm; step (b) comprises dispensing a dispersion, slurry, or suspension of elliptically-shaped magnetic particles with particle sizes <˜10 nm, the concentration of particles in the dispersion, slurry, or suspension being <˜50% by-volume, the dispensing rate being from ˜5 cc/min. to ˜50 cc/min., the dispensing conducted for an interval sufficient to form the tilted perpendicular magnetic recording layer to a thickness from ˜100 Å to ˜200 Å, and supplying the radially tilted magnetic field at a preselected, controllable angle by means of a controllably tiltable permanent or DC electromagnet having a field strength from ˜10 kOe to ˜40 kOe, e.g., 15 kOe, and a flux density from ˜50 MGauss/cm² to ˜75 MGauss/cm²; step (c) comprises removing the vehicle or carrier liquid from the spin-coated layer by heating in an inert gas atmosphere or in an inert gas atmosphere containing a minor amount of oxygen; and step (d) comprises annealing the spin-coated layer at a temperature <˜300° C. for at least ˜1 hr. in a reduced pressure atmosphere consisting of an inert gas or an inert gas containing a minor amount of oxygen.

Another aspect of the present invention is a perpendicular magnetic recording medium, comprising:

(a) a non-magnetic substrate including a surface with at least one requisite thin-film layer for a perpendicular magnetic recording medium formed thereon; and

(b) a tilted perpendicular magnetic recording layer on an outer surface of the at least one requisite thin film layer, wherein the easy axis of magnetization of magnetic particles of the recording layer is tilted in a radial direction at a preselected, controllable angle up to about 45° from vertical.

According to preferred embodiments of the present invention, the non-magnetic substrate (a) is disk-shaped and comprised of a material selected from the group consisting of non-magnetic metals or alloys, glass, ceramics, glass-ceramics, polymeric materials, and composite or laminates of same; and the at least one requisite thin film layer includes an underlayer or keeper layer of a soft magnetic material, or a combination of an underlayer or keeper layer of a soft magnetic material and an overlying non-magnetic interlayer forming an outermost layer of a layer stack; and the tilted perpendicular magnetic recording layer (b) comprises an ˜100 Å to an ˜200 Å thick layer of nano-sized magnetic particles selected from the group consisting of CoPt magnetic alloys, FePt magnetic alloys, and other magnetic alloys utilized for forming perpendicular magnetic alloys.

In accordance with further preferred embodiments of the invention, the CoPt magnetic alloys include CoPt, CoCrPt, CoCrPtB, and CoCrPtSiO)₂ alloys, and said FePt alloys include FePt, FeCoPt, and FeRuPt alloys; and the nano-sized magnetic particles are elliptically-shaped with particle sizes <˜10 nm.

Yet further preferred embodiments of the present invention include those wherein the nano-sized magnetic particles of the tilted perpendicular magnetic recording layer are embedded in a glass-like matrix derived from a silica sol-gel.

Still further preferred embodiments of the magnetic media of the present invention additionally comprise:

(c) a protective overcoat layer on the tilted perpendicular magnetic recording layer; and

(d) a lubricant topcoat layer on the protective overcoat layer.

Yet another aspect of the present invention is an apparatus for forming a magnetic recording medium, comprising:

(a) means for supporting and rotating a disk-shaped precursor workpiece for a recording medium about a central axis; and

(b) means for forming a tilted perpendicular magnetic recording layer on the precursor workpiece, wherein the easy axis of magnetization of magnetic particles of the recording layer is tilted in a radial direction at a preselected, controllable angle up to about 45° from vertical.

According to embodiments of the present invention, means (a) for supporting and rotating a precursor workpiece comprises a turntable; and means (b) for forming a tilted perpendicular magnetic recording layer comprises:

(i) a means for dispensing a dispersion, slurry, or suspension of the magnetic particles in a vehicle or carrier liquid onto a surface of a precursor workpiece supported on the turntable; and

(ii) a means for orienting the easy axis of magnetization of the magnetic particles in a radial direction at the preselected tilted angle up to about 45° from vertical; wherein: means (b)(ii) for radially orienting the easy axis of magnetization of said magnetic particles at the preselected tilted angle from vertical comprises a permanent or DC electromagnet adapted for applying a radially oriented magnetic field to the particles which is tilted at the preselected, controllable angle up to about 45° from vertical.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, and in which like reference numerals are employed throughout to designate similar features, wherein:

FIG. 1 schematically illustrates, in simplified, cross-sectional view, a portion of a magnetic recording, storage, and retrieval system comprised of a conventional perpendicular-type magnetic recording medium and a single-pole transducer head;

FIG. 2 schematically illustrates, in simplified, cross-sectional view, a portion of a magnetic recording, storage, and retrieval system according to an embodiment of the present invention, comprised of a perpendicular-type magnetic recording medium including a tilted perpendicular magnetic recording layer and a single-pole transducer head; and

FIG. 3 schematically illustrates, in perspective view, an embodiment of an apparatus for performing the method of the present invention for manufacturing a magnetic recording medium comprising a tilted perpendicular magnetic recording layer.

### DESCRIPTION OF THE INVENTION

The present invention is based upon the recognition that high areal recording density, highly anisotropic perpendicular magnetic recording media with improved signal-to-medium noise ratios (SMNR) and comprising a tilted perpendicular magnetic recording layer including a plurality of nano-sized, single domain magnetic particles wherein the easy axis of magnetization of each particle is tilted in a radial direction at a preselected, controllable angle up to about 45° from vertical, can be reliably and controllably manufactured by a simple, cost-effective technique.

According to a feature of the invention, the tilted perpendicular magnetic recording layer comprised of a plurality of single domain magnetic particles is formed on a precursor workpiece for the medium (i.e., a disk-shaped non-magnetic substrate including on at least one surface thereof at least one requisite thin film layer of a perpendicular magnetic recording medium, e.g., a magnetically soft underlayer) by a spin coating process utilizing an appropriately configured apparatus, whereby a dispersion, slurry, or suspension of the magnetic particles is applied to a surface of the precursor workpiece via a dispensing nozzle, the precursor workpiece is rotated about a central axis to effect spreading of the dispersion, slurry, or suspension to achieve a uniform layer thickness, and a magnetic alignment field is applied thereto which is tilted in a radial direction at a preselected, controllable angle up to about 45° from vertical.

The inventive methodology affords a number of advantages not previously obtainable in the fabrication of perpendicular magnetic recording media, including, inter alia, the ability to readily form advantageous tilted perpendicular magnetic recording layers with preselected, controllable tilt angles in a cost-effective manner utilizing conventional or readily modified manufacturing techniques and instrumentalities, e.g., spin coating techniques and apparatus.

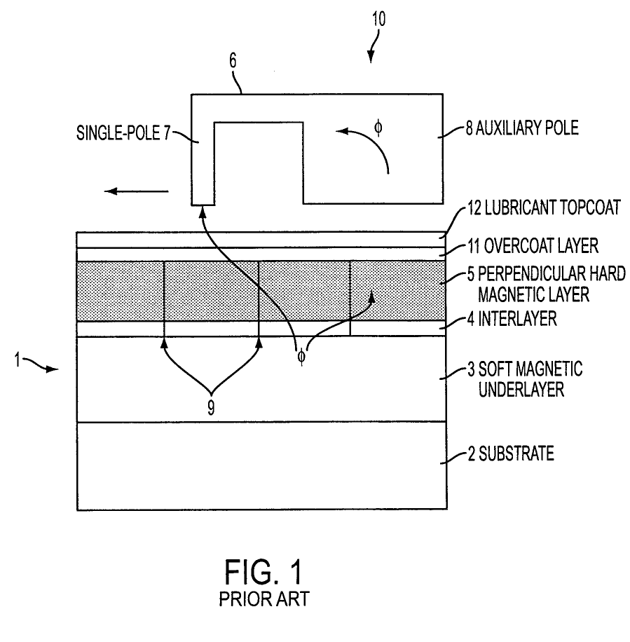

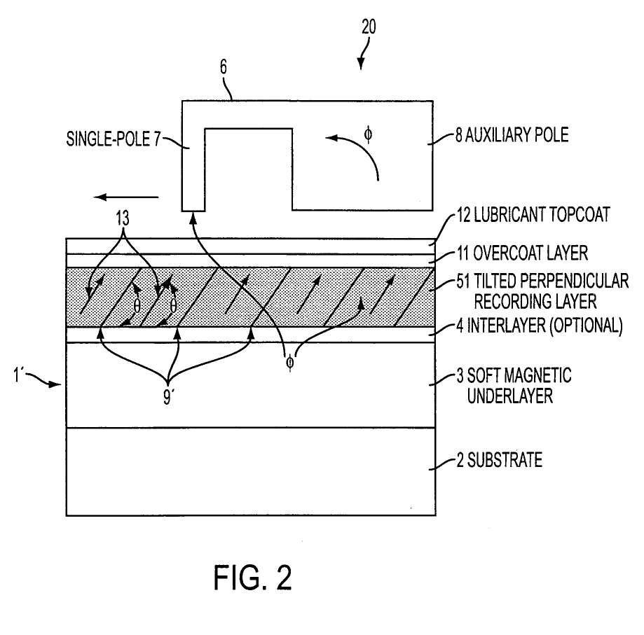

Referring to FIG. 2, shown therein, in simplified, cross-sectional view, is a portion of a magnetic recording, storage, and retrieval system 20 according to an embodiment of the present invention, comprised of a perpendicular-type magnetic recording medium 1′ including a radially tilted perpendicular magnetic recording layer 5′ and a single-pole transducer head 6. Perpendicular-type magnetic recording medium 1′ is generally similar in structure to medium 1 of FIG. 1, i.e., reference numerals 2, 3, 4, and 5′, respectively, indicate the substrate, the soft magnetic underlayer, the at least one non-magnetic interlayer (optional in this case), and the radially tilted perpendicular magnetic recording layer according to the invention, and reference numerals 7 and 8, respectively, indicate the single and auxiliary poles of single-pole magnetic transducer head 6.

Substrate 2 is typically disk-shaped and comprised of a non-magnetic metal or alloy, e.g., Al or an Al-based alloy, such as Al—Mg having an Ni—P plating layer on the deposition surface thereof, or substrate 2 is comprised of a suitable glass, ceramic, glass-ceramic, polymeric material, or a composite or laminate of these materials; soft magnetic underlayer 3 is typically comprised of an about 500 to about 4,000 Å thick layer of a soft magnetic material selected from the group consisting of Ni, NiFe (Permalloy), Co, CoZr, CoZrCr, CoZrNb, CoFe, Fe, FeN, FeSiAl, FeSiAlN, FeCoC, FeCoB, etc.; and optional interlayer 4, if present, typically comprises an up to about 300 Å thick layer of a non-magnetic material, such as TiCr.

A protective overcoat layer 11, such as of a diamond-like carbon (DLC), is formed over the tilted perpendicular magnetic recording layer 5′, and a lubricant topcoat layer 12, e.g., of a perfluoropolyethylene material, is formed over the protective overcoat layer.

As shown by the arrows in the figure indicating the path of the magnetic flux φ, flux φ emanates from single pole 7 of single-pole magnetic transducer head 6, enters and passes through the tilted perpendicular magnetic recording layer 5′ in the region above single pole 7, enters and travels along soft magnetic underlayer 3 for a distance, and then exits therefrom and passes through the tilted perpendicular magnetic recording layer 5′ in the region above auxiliary pole 8 of single-pole magnetic transducer head 6. The direction of movement of perpendicular magnetic medium 1 past transducer head 6 is indicated in the figure by the arrow above medium 1.

With continued reference to FIG. 2, lines 9′, tilted in a radial direction at a preselected, controllable angle θ from vertical, indicate boundaries between each tilted single domain magnetic particle constituting tilted perpendicular magnetic recording layer 5′, wherein θ is controllably variable and ranges up to 45°, with 45° being preferred, and lines 13 tilted at an angle θ′ from vertical (where θ′≈θ) indicate the radially oriented, tilted easy axis of magnetization of the magnetic domain of the particle, typically the c-axis.

According to embodiments of the invention, the tilted perpendicular magnetic recording layer 5′ comprises an ˜100 Å to an ˜200 Å thick layer of nano-sized magnetic particles, preferably elliptically-shaped with particle sizes <˜10 nm, of magnetic materials selected from among CoPt magnetic alloys such as CoPt, CoCrPt, CoCrPtB, and CoCrPtSiO₂; FePt magnetic alloys such as FePt, FeCoPt, and FeRuPt alloys; and other magnetic alloys typically utilized for forming perpendicular magnetic recording layers. In accordance with certain embodiments of the invention, the nano-sized magnetic particles of the tilted perpendicular magnetic recording layer are embedded in a glass-like matrix derived from a silica sol-gel by driving off the solvent of a silica sol-gel vehicle or carrier liquid from the slurry, dispersion, or suspension of magnetic particles and converting the remaining silica sol-gel to a glass-like layer.

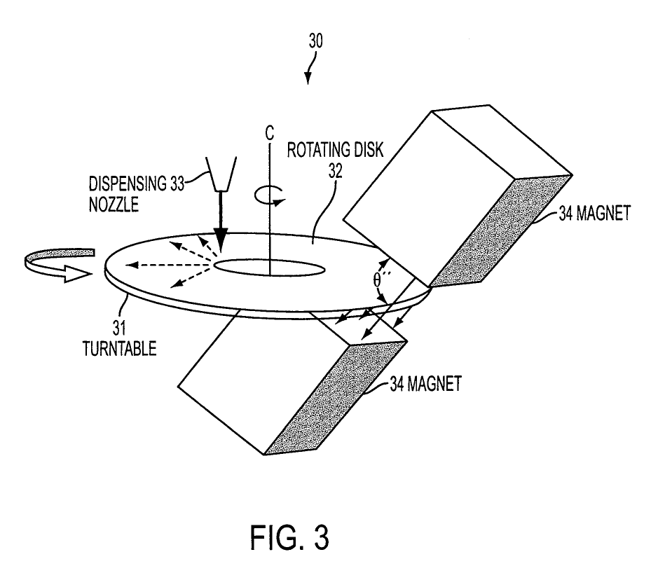

Adverting to FIG. 3, shown therein, in simplified, schematic perspective view, is an embodiment of an apparatus 30 for performing the method of the present invention for manufacturing a magnetic recording medium comprising a tilted perpendicular magnetic recording layer. As illustrated, apparatus 30 comprises a turntable 31 adapted for mounting thereon a disk-shaped precursor workpiece 32 for a perpendicular magnetic recording medium, typically in the form of an annular disk, for rotation about a central axis c. A nozzle 33 or functionally equivalent means adapted for dispensing a dispersion, slurry, or suspension of nano-sized magnetic particles in a suitable vehicle or carrier liquid is positioned above the exposed upper surface of the rotating, annular disk-shaped precursor workpiece 32 adjacent the inner circumference thereof. Spin coating apparatus 30 further includes a controllably tiltable magnet means 34 (either a permanent or DC electromagnet) for applying a radially oriented magnetic alignment field 35 to the spin-coated layer of magnetic particles at a preselected, controllable angle θ″≈θ′=θ tilted from vertical to the deposition surface of the precursor workpiece, in order to form tilted perpendicular magnetic recording layer 5′.

In performing spin coating of a tilted perpendicular magnetic recording layer according to the invention, a dispersion, slurry, or suspension of nano-sized, single domain magnetic particles comprised of the aforementioned materials, preferably elliptically-shaped and with particle sizes <˜10 nm (as, for example, disclosed in IEEE Trans. Magn., 37, 1239-1243 (2001)) is prepared with a particle concentration <˜50% by volume, preferably <˜20% by volume. Typically, a mixture of water and an alcohol is utilized as a vehicle or liquid carrier for forming the dispersion, slurry, or suspension. In instances where a dispersion, slurry, or suspension of magnetic particles in a silica sol-gel as vehicle or carrier liquid is utilized for the spin coating process in order to form a tilted perpendicular magnetic recording layer comprising the nano-sized single domain magnetic particles embedded in a glass-like layer derived from the silica sol-gel, a suitable vehicle or carrier liquid may comprise a mixture of tetraethoxysilane (“TEOS”) and water in a 1:5 molar ratio, with a small amount of added acid added as a catalyst, or with an alcohol such as butanol added at a TEOS/butanol molar ratio of 1:4.

The speed of rotation of turntable 31 about central axis c during dispensing of the dispersion, slurry, or suspension of magnetic particles from nozzle 33 depends upon the viscosity of the dispersion, slurry, or suspension, i.e., the greater the viscosity, the higher the speed of rotation. Rotation speeds typically range from ˜1,000 to ˜5,000 rpm. Dispense rates of the dispersion, slurry, or suspension from nozzle 33 for forming an about 100-200 Å thick tilted perpendicular magnetic recording layer on a 95 mm (outer diameter) annular disk-shaped precursor workpiece 32 for a hard disk in a typical spin coating interval of about 15 min., range from ˜5 cc/min. to ˜50 cc/min. The strength of the controllably tilted magnetic alignment field 35 supplied by permanent or DC electromagnet means 34 for achieving preselected tilt angles θ and θ′ of the magnetic particles and their easy axes, respectively, i.e., preferably about 45°, ranges from ˜10 kOe to ˜40 kOe, e.g., about 15 kOe, with flux densities ranging from ˜50 MGauss/cm² to about 75 MGauss/cm² Subsequent to formation of an appropriately thick tilted perpendicular magnetic recording layer 5′ with preselected tilt angle, e.g., ˜100 Å to ˜200 Å, layer 5′ is subjected to treatment at a suitable temperature and interval for removing the vehicle or carrier liquid, as by heating in an inert gas atmosphere (e.g., Ar) to prevent oxidation of the magnetic alloy of the particles, or by heating in an inert gas atmosphere (e.g., Ar) containing a minor amount of oxygen in instances where the magnetic alloy of the particles comprises an oxide, e.g., CoCrPtSiO₂. Higher solvent removal temperatures may be necessary when the vehicle or carrier liquid comprises a silica sol-gel when forming a tilted perpendicular recording layer comprising magnetic particles embedded in a glass-like layer.

A further annealing step may be performed for a duration ranging from ˜1 hr. to several days in order to assist in solvent removal and to optimize the magnetic characteristics of layer 5′. The annealing temperature is preferably below ˜300° C. and the annealing should be performed in a reduced pressure atmosphere in atmospheres similar to those employed for the previously described solvent removal step.

The present invention thus advantageously provides high quality, high areal recording density tilted perpendicular magnetic recording media, which media achieve improved writing of highly anisotropic recording layers with improved SMNR via a perpendicular ferromagnetic recording layer comprised of a plurality of radially tilted single domain magnetic particles wherein the easy axis of magnetization of each particle is radially oriented at a preselected, controllably tilted angle up to about 45° with respect to the read/write transducer head. Moreover, the inventive methodology for manufacturing such radially tilted perpendicular magnetic recording media can be practiced in a cost-effective manner utilizing modified conventional manufacturing technology and equipment (e.g., spin coating technology/equipment) for automated, large-scale manufacture of magnetic recording media, such as hard disks. Finally, the invention is not limited to use with hard disks but rather is broadly applicable to the formation of high areal density perpendicular magnetic recording media suitable for use in all manner of devices, products, and applications.

In the previous description, numerous specific details are set forth, such as specific materials, structures, processes, etc., in order to provide a better understanding of the present invention. However, the present invention can be practiced without resorting to the details specifically set forth herein. In other instances, well-known processing techniques and structures have not been described in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

1. (canceled)

2. (canceled)

3. A method for manufacturing a magnetic recording medium comprising sequential steps of:
(a) providing a disk-shaped precursor workpiece for a perpendicular magnetic recording medium including a non-magnetic substrate with at least one requisite thin film layer for a perpendicular magnetic recording medium formed thereon and rotating said precursor workpiece about a central axis; and
(b) forming a spin-coated tilted perpendicular magnetic recording layer on an outer surface of said at least one thin film layer by dispensing thereon a dispersion, slurry, or suspension of magnetic particles in a vehicle or carrier liquid while applying a radially oriented magnetic alignment field thereto which is tilted at a preselected, controllable angle up to about 45° from vertical, wherein the easy axis of magnetization of the magnetic particles of said recording layer is tilted in a radial direction at a preselected controllable angle up to about 45° from vertical.

4. The method according to claim 3, further comprising a step of:
(c) removing said vehicle or carrier liquid from said spin-coated layer.

5. The method according to claim 4, wherein:
step (c) comprises heating said spin-coated tilted perpendicular magnetic recording layer at a temperature below the Curie temperature of said magnetic particles.

6. The method according to claim 4, wherein:
step (b) comprises forming said spin-coated tilted perpendicular magnetic recording layer on said outer surface of said at least one thin film layer by dispensing thereon a dispersion, slurry, or suspension of said magnetic particles in a vehicle or carrier liquid comprising a silica sol-gel in a solvent; and
step (c) comprises removing said solvent to form a tilted perpendicular magnetic recording layer comprising said magnetic particles embedded in a glass-like matrix derived from said silica sol-gel.

7. The method according to claim 4, further comprising a step of:
(d) annealing said spin-coated tilted perpendicular magnetic recording layer.

8. The method according to claim 7, wherein:
step (a) comprises providing a disk-shaped precursor workpiece including a non-magnetic substrate comprised of a material selected from the group consisting of non-magnetic metals or alloys, glass, ceramics, glass-ceramics, polymeric materials, and composite or laminates of same; and said at least one requisite thin film layer for a perpendicular magnetic recording medium includes an underlayer or keeper layer of a soft magnetic material, or a combination of an underlayer or keeper layer of a soft magnetic material and an overlying non-magnetic interlayer forming an outermost layer of a layer stack; and
step (b) comprises dispensing a dispersion, slurry, or suspension of nano-sized magnetic particles.

9. The method according to claim 8, wherein:
step (a) comprises rotating said precursor workpiece about said central axis at a speed proportional to the viscosity of said dispersion, slurry, or suspension of said magnetic particles;
step (b) comprises dispensing a dispersion, slurry, or suspension of nano-sized magnetic particles selected from the group consisting of: CoPt magnetic alloys, FePt magnetic alloys, and other magnetic alloys utilized for forming perpendicular magnetic recording layers.

10. The method according to claim 9, wherein:
step (a) comprises rotating said precursor workpiece at a speed from ˜1,000 rpm to ˜5,000 rpm;
step (b) comprises dispensing a dispersion, slurry, or suspension of elliptically-shaped magnetic particles with particle sizes <˜10 nm, the concentration of particles in said dispersion, slurry, or suspension being <˜50% by volume, the dispensing rate being from ˜5 cc/min. to ˜50 cc/min., said dispensing conducted for an interval sufficient to form said tilted perpendicular magnetic recording layer to a thickness from ˜100 Å to ˜200 Å, and applying said tilted magnetic field at a preselected, controllable angle by means of a controllably tiltable permanent or DC electromagnet having a field strength from ˜10 kOe to ˜40 kOe and a flux density from ˜50 MGauss/cm² to ˜75 MGauss/cm²;
step (c) comprises removing said vehicle or carrier liquid from said spin-coated layer by heating in an inert gas atmosphere or in an inert gas atmosphere containing a minor amount of oxygen; and
step (d) comprises annealing said spin-coated layer at a temperature <˜300° C. for at least ˜1 hr. in a reduced pressure atmosphere consisting of an inert gas or an inert gas containing a minor amount of oxygen.

11-17. (canceled)

18. An apparatus for forming a magnetic recording medium, comprising:
(a) means for supporting and rotating a disk-shaped precursor workpiece for a said recording medium about a central axis; and
(b) means for forming a tilted perpendicular magnetic recording layer on said precursor workpiece, wherein the easy axis of magnetization of magnetic particles of said recording layer is tilted in a radial direction at a preselected, controllable angle up to about 45 from vertical.

19. The apparatus as in claim 18, wherein:
said means (a) for supporting and rotating a precursor workpiece comprises a turntable; and
said means (b) for forming a tilted perpendicular magnetic recording layer comprises:
(i) a means for dispensing a dispersion, slurry, or suspension of said magnetic particles in a vehicle or carrier liquid onto a surface of a precursor workpiece supported on said turntable; and
(ii) a means for orienting said easy axis of magnetization of said magnetic particles in a radial direction at said preselected tilted angle up to about 45° from vertical.

20. The apparatus as in claim 19, wherein:
said means (b)(ii) for orienting said easy axis of magnetization of said magnetic particles in a radial direction at said preselected tilted angle from vertical comprises a permanent or DC electromagnet adapted for applying a radially oriented magnetic field to said particles which is tilted at said preselected angle up to about 45 from vertical.
